(19) United States
(12) Patent Application Publication
(10) Pub. No.: US 2002/0085004 A1
(43) Pub. Date: Jul. 4, 2002

(54) Blending method for accomplishing continuity at boundary of two b-spline curves / surfaces for use in a computing apparatus

(76) Inventors: Choong-Gyoo Lim, Taejon (KR); Young-Ho Suh, Taejon (KR); Weon-Geun Oh, Taejon (KR)

Correspondence Address: JACOBSON, PRICE, HOLMAN & STERN, PROFESSIONAL LIMITED LIABILITY COMPANY, 400 Seventh Street, N.W., Washington, DC, 20004, US

(21) Appl. No.: 09/938,654

(22) Filed: Aug. 27, 2001

(30) Foreign Application Priority Data
Dec. 30, 2000 (KR) 2000-86721

(51) Int. Cl. G06T 11/20

(52) U.S. Cl. 345/441

(57) ABSTRACT

An algebraic blending method accomplishes continuity of two n-the order curves or curved surface patch by generating a new control point of boundary by using a simple algebraic blending method in modeling a free curves/curved surface constructed by a B-spline. At a first step, a B-spline curved surface patch is obtained by using universal parametrization. At a second step, two adjacent patch to be connected with continuity is selected among the patch obtained at the first step. At a third step, at least one control point of a large patch is obtained by obtaining control points of the selected two curved surfaces and blending superposed control points. At a final step, a B-spline curved surface patch is obtained by using the obtained control points of the large patch and the two patch of the original model is replaced with the B-spline curved surface patch.

### FIELD OF THE INVENTION

The present invention relates to an algebraic blending method for accomplishing maximum continuity of two neighboring curves or surfaces for use in a computing apparatus of various type modeling by using B-spline curves and a computer readable medium for recording a program for implementing the method.

### PRIOR ART OF THE INVENTION

Conventionally, there have been various methods for accomplishing continuity of surface patches to obtain a smooth surface model in an apparatus, e.g., a three dimension modeling apparatus using the free-form surface. In general, there is provided a method for adjusting a control point within the curved surface of each patch with respect to G⁰ or G¹ continuity at a boundary curves of a curved surface model constructed by using Be zier, NURBS, or a Gregory Patch.

The Be zier surface is frequently used for free-form surface modeling. Its conditions for G¹ and G²continuity of two curved surfaces are well known and relatively easy to use. However, there is a shortcoming of increasing the order of the curved surface as the number of the control points of the curved surface increases.

The NURBS surface is also used in a CAD or a three dimension modeler and can represent a free-form surface with more control points at lower order. In general, conditions for G¹ and G² continuity are not known yet.

The Gregory Patch is a modification of the Be zier curved surface specially designed in order to have G¹ continuity. As with the Be zier curved surface, as the number of the control points increases, the order of the curved surface increases.

The B-spline curved surface is widely used in modeling free-form surfaces and can evaluate the free-form surfaces from the point data by simple iterative computation. NURBS surfaces are in more general representation than B-spline surfaces.

Because the continuity condition for the boundary of the curved surface are involved with complicated derivative functions, computational expense is high and it is hard to accomplish more than G¹ or C¹ continuity.

Furthermore, though a numerical method is used to determine a proper control point, there is a case requesting more than G¹ or C¹ continuity in the art of CAD/CAM, which cannot be satisfied because of the complexity of the derivative function at the boundary.

### SUMMARY OF THE INVENTION

Therefore, it is an object of the present invention to provide an algebraic blending method for accomplishing continuity of two n-th order curves or surface patches by generating a new set of control points at boundary by using a simple algebraic blending method in modeling a smooth curve/surface constructed by a B-5pline and a computer readable medium for recording a program for implementing the method.

In accordance with an aspect of the present invention, there is provided an algebraic blending method for accomplishing continuity at boundary of two B-spline curves or curved surfaces for use in a computing apparatus, the method comprising the steps of (a) obtaining a B-spline surface patch by using universal parametrization, (b) selecting two adjacent patches to be connected with continuity between the patches obtained at the step (a), (c) obtaining control points of a large patch by obtaining control points of the selected two surfaces and blending superposed control points, and (d) obtaining a B-spline surface patch by using the obtained control points of the large patch and replacing it with the two patches of the original model.

In accordance with another aspect of the present invention, there is provided an algebraic blending method for accomplishing continuity at boundary of two B-spline curves or surfaces for use in a computing apparatus, the method comprising the steps of (a) selecting two adjacent patch and selecting a proper blending method, (b) checking whether the selected two patch have same number of the control points, (c) if the two patch have same number of the control points, obtaining superposed control points of the two patch, blending the corresponding control points by the selected blending method to a new control points, and generating a B-spline surface patch by using the new control points, and (d) if the two patch does not have same number of the control points at boundary, inserting knots to the patch having less control points, obtaining control points superposed at the two patch of the step (c), blending the corresponding control points by the selected blending method, and proceeding to the step of obtaining the new control points.

In accordance with still another aspect of the present invention, there is provided a method for separating two B-spline curves to two curves for use in a computing apparatus, the method comprising the steps of (a) selecting the B-spline curve and separating the selected B-spline curve by selecting a control point d₁ at which the selected B-spline curve is separated, (b) constructing control points of one curve of the separated curves by d₁, d₂, . . . d₁, . . . d₁₊ₖ₋₂ and arbitrary k−1 points d¹ ₙ₋₁, d¹ₙ and constructing control points of the other curve of the separated curves by arbitrary k−1 points d²₁, d²₂ and dᵢ₋ₖ₊₂, . . . , dᵢ, dᵢ₊₁, . . . dₙ, and (c) setting respectively the separated two curves to parameters corresponding to the control point dᵢ.

In accordance with still another aspect of the present invention, there is provided a computer readable medium for recording a program for implementing in a geometric modeling apparatus the functions of (a) obtaining a B-spline surface patch by using universal parameters, (b) selecting two adjacent patch to be connected with continuity between the patches obtained by the function (a), (c) obtaining control points of a large patch by obtaining control points of the two selected surfaces and blending superposed control points, and (d) obtaining a B-spline curved surface patch by using the obtained control points of the large patch and replacing it with the two patch of the original model.

In accordance with still another aspect of the present invention, there is provided a computer readable medium for recording a program for implementing in a geometric modeling apparatus the functions of (a) selecting two adjacent patch and selecting a proper blending method, (b) checking whether the selected two patches have the same number of the control points, (c) if the two patches have the same number of the control points, obtaining superposed control points of the two patches, blending the corresponding control points by the selected blending method to a new control points, and generating a B-spline surface patch by using the new control points, and (d) if the two patches does not have same number of the control points in direction of boundary, inserting Knots to the patch having less control points, obtaining control points superposed at the two patches of the function (c), blending the corresponding control points by the selected blending method, and proceeding to the step of obtaining the new control points.

In accordance with still an aspect of the present invention, there is provided a computer readable medium for recording a program for implementing in a geometric modeling apparatus the functions of (a) selecting the B-spline curve and separating the selected B-spline curve by selecting a control point dᵢ at which the selected B-spline curve is separated, (b) constructing control points of one curve of the separated curves by d₁, d₂, . . . , dᵢ, . . . , dᵢ₊ₖ₋₂ and arbitrary k−1 points d¹_{n -}, d¹ₙ and constructing control points of the other curve of the separated curves by arbitrary k−1 points d²₁, d₂² and dᵢ₋ₖ₊₂, . . . , dᵢ, dᵢ₊₁, dₙ, and (c) setting respectively the separated two curves to parameters corresponding to the control point dᵢ.

### BRIEF DESCRIPTION OF THE DRAWINGS

The above and other objects and features of the instant invention will become apparent from the following description of embodiments taken in conjunction with the accompanying drawings, in which:

FIG. 1 shows a diagram of one embodiment of a method for determining a control point of a new curve after obtaining two B-spline curves to have two control points superposed in accordance with the present invention;

FIG. 2 offers a diagram of one embodiment of a third degree B-spline curve obtained in FIG. 1;

FIG. 3 illustrates a diagram of one embodiment of a method for determining a control point of a new curve after obtaining two B-spline curves to have three control points superposed in accordance with the present invention;

FIG. 4 provides a diagram of one embodiment of a curve obtained in FIG. 3;

FIG. 5 is a diagram of one embodiment of a method for separating a B-spline curve to two curves in accordance with the present invention;

FIG. 6 shows a diagram of one embodiment of separated curves in FIG. 5;

FIG. 7 offers diagram of one embodiment of a method for determining a new control point by algebraically blending on control points of two surface patches sharing a boundary curve in accordance with the present invention;

FIG. 8 presents a diagram of a new control point Ci, obtained by a method in FIG. 7;

FIGS. 9A to 9C show diagrams of one embodiment of a blending method in accordance with the present invention;

FIG. 10 is a flow chart for one embodiment of an algebraic blending method for accomplishing cⁿ⁻¹ continuity at boundary of two B-spline curves/curved surfaces in accordance with the present invention;

FIG. 11 is a flow chart for another embodiment of an algebraic blending method for accomplishing cⁿ⁻¹ continuity at boundary of two B-spline curves/surfaces in accordance with the present invention;

FIG. 12 shows a diagram for one embodiment of a method for separating a B-spline curve to two curves in accordance with the present invention.

### PREFERRED EMBODIMENT OF THE INVENTION

Hereinafter, preferred embodiments of the present invention and measurement results will be described in detail with reference to the accompanying drawings.

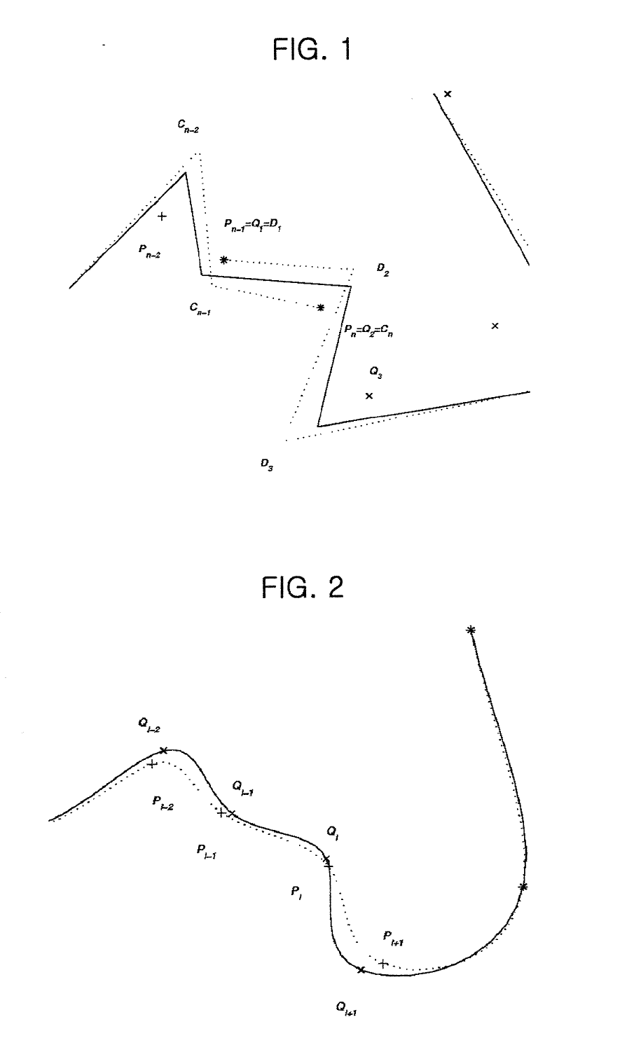

FIG. 1 shows a diagram of one embodiment of a method for determining a control point of a new curve after obtaining two B-spline curves to have two control points superposed of the present invention.

The algebraic blending method of the present invention can be executed by a known computing apparatus having a processor.

In FIG. 1, there are shown control points C₁, C₂, . . . , Cₙ obtained from point data P₁, P₂, . . . , Pₙ of a first curve and control points D₁, D₂, . . . , Dₘ obtained from point data Q₁, Q₂, . . . , Qₘ of a second curve.

The points Pₙ₋₁ and Q₁ are equal and the points Pₙ and Q₂ are equal. By obtaining two curves respectively and blending algebraically control points Cₙ₋₁ and D₁, Cₙ and D₂ the control point of the new curve is generated. For example, as the new control point, αCᵢ+βDⱼ (α+β=1, α,β,≧0) can be used.

Solid lines are control polygon of the curve obtained by using all given point data.

FIG. 2 offers a diagram of one embodiment of a third order B-spline curve obtained by the method in FIG. 1.

As shown in FIG. 2, a dotted line is the third order B-spline curve obtained by using all given point data and a solid line is produced by obtaining two curves as shown in FIG. 1 and algebraically blending the control points superposed.

When two separate curves are required, by using local support characteristic of the B-spline, control points of the curve to separated control point and an adjacent control point (for the third order curve) are appended and two or more arbitrary control points are appended. Here, computation of the curve is executed to a knot value at which separation is started.

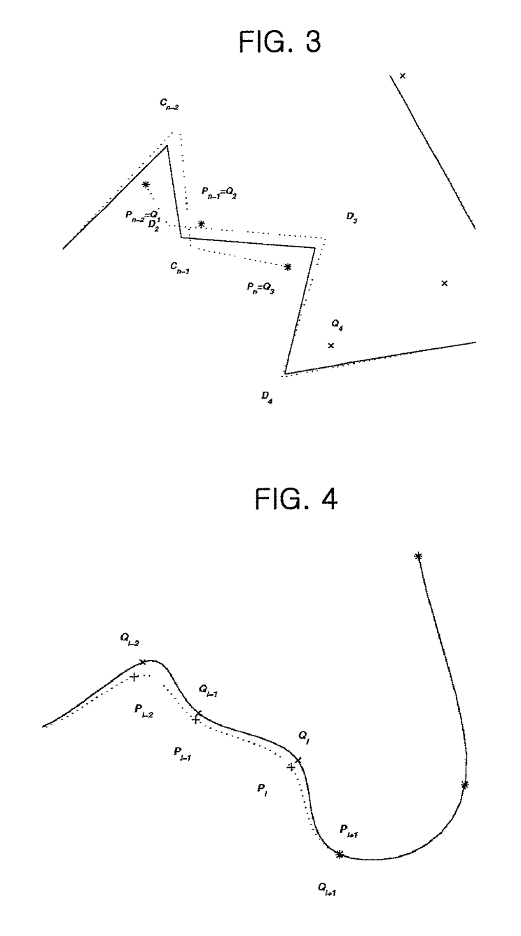

FIG. 3 illustrates a diagram of one embodiment of a method for determining a control point of a new curve after obtaining three B-spline curves to have two control points superposed in accordance with the present invention.

Control points C₁, C₂, . . . , Cₙ are obtained from point data P₁, P₂, . . . , Pₙ of a first curve and control points D₁, D₂, . . . , Dₘ are obtained from point data Q₁, Q₂, . . . Qₘ of a second curve. In FIG. 1, two superposed points are used and, in FIG. 3, three superposed points are used. That is, the points Pₙ₋₂ and Q₁, Pₙ₋₁ and Q₂, and are equal.

Solid lines are control polygon of the curve connecting the control points, which is obtained by using all given point data. By blending algebraically as in FIG. 1 control points Cₙ₋₂ and D₁, Cₙ₋₁ and D₂, and Cₙ and D₂ of the two curves, the control point of the new curve is generated. When two separate curves are required, a first control point of the second curve and arbitrary two control points to separated control point are appended.

FIG. 4 provides a diagram of one embodiment of a curve obtained in FIG. 3.

As shown in FIG. 4, a dotted line is a curve obtained by using all given point data and a solid line is a curve constructed by control points obtained by the method in FIG. 3.

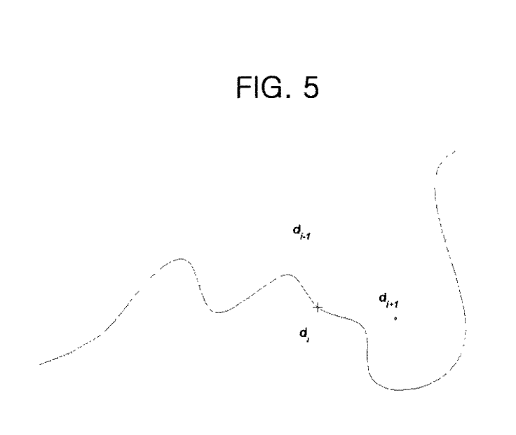

FIG. 5 is a diagram of one embodiment of a method for separating a B-spline curve to two curves in accordance with the present invention.

In FIG. 5, a curve represented by ‘+’ is separated to two curves and the control point corresponding to separation is d₁.

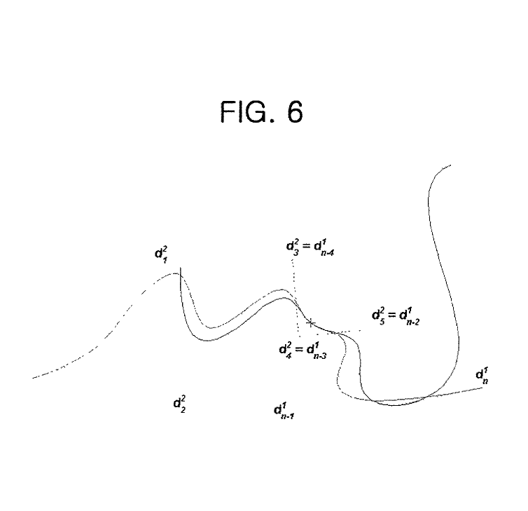

FIG. 6 shows a diagram of one embodiment of separated curves in FIG. 5.

In order to retain the original curve and continuity, the control point d₁ in FIG. 5 is shared by d₁ⁿ⁻³ of a curve 1 and d₄² of a curve 2 and dᵢ₋₁ and dᵢ₊₁ in FIG. 5 are appended to d₂³ of the curve 2 and d₁ⁿ⁻¹ of the curve 1.

Arbitrary points d₁ⁿ⁻¹ and d₁ⁿ are appended to the curve 1 and arbitrary points d₂¹ and d₂² are appended to the curve 2.

The localness of the B-spline curve enables this separation. Here, the localness means that effect of the control point is limited locally.

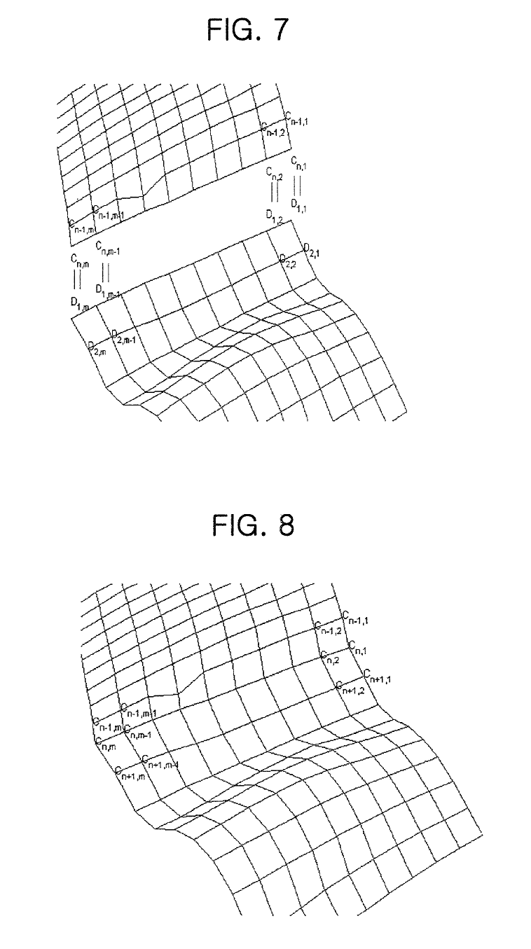

FIG. 7 offers diagram of one embodiment of a method for determining a new control point by algebraic blending on a control point obtained by obtaining two curved surface patches sharing curved surface points of a line in accordance with the present invention, in which a method for determining a new control point C′_{y}(i=1, 2, . . . , n+l−1, j=1, 2, . . . , m) by blending algebraically control points C_{y}(i=1, 2, . . . , n, j=2, 3, . . . , m) and Dᵢⱼ (i=1, 2, . . . , l, j=1, 2,. . . , m) obtained by two curved surface patch sharing curved surface points of a line.

Because two curved surface patch share the curved surface points of the boundary line, control point Cₙ is equal to D_{1,}. Here, because two control point lines are equal, the control point line is used as it is.

FIG. 8 presents a diagram of a new control point C_{g} obtained by a method in FIG. 7.

When two separate curves are required, a first line of a control point network of a curved surface adjacent to a control point network of a patch to a control point line separated is appended and two arbitrary control points are appended. In computation of the curved surface, computation of the curve is executed to a knot value at which separation is started.

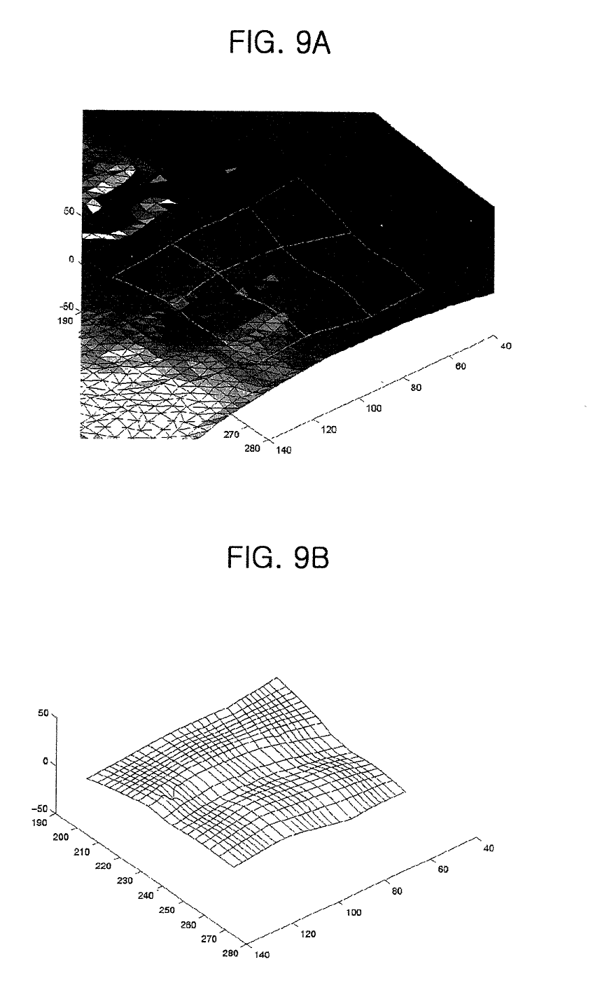

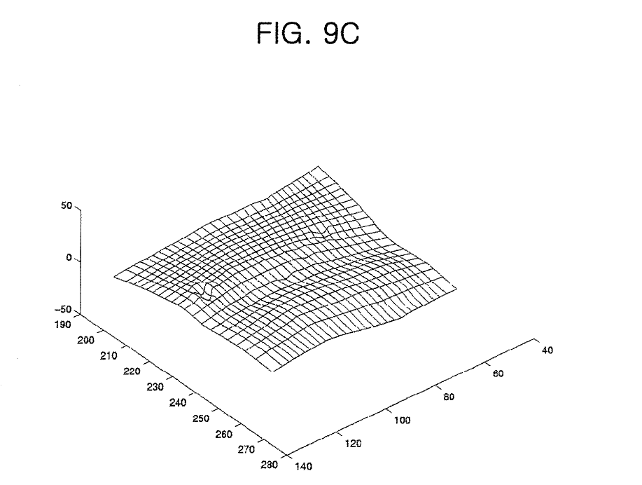

FIGS. 9A to 9C show diagrams of one embodiment of a blending method in accordance with the present invention.

A polygon mesh is shown in FIG. 9A and six curved surface patch having G⁰ continuity in FIG. 9B. In FIG. 9C, another curved surface patch having Cⁿ⁻¹ continuity is shown.

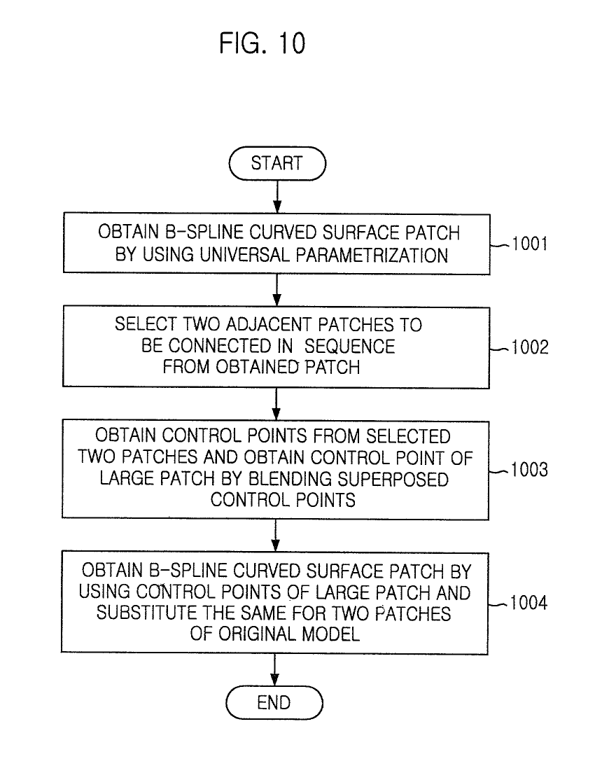

FIG. 10 is a flow chart for one embodiment of an algebraic blending method for accomplishing Cⁿ⁻¹ continuity at boundary of two B-spline curves/curved surfaces in accordance with the present invention.

As shown in FIG. 10, at step 1001, a B-spline curved surface patch is obtained by using a universal parametrization. Here, the universal parametrization assigns a proper parameter value tₗ to arbitrary point data Pₗ and a type of a final curve or curved surface has much effect in obtaining the curve or curved surface by interpolation or approximation. Also, the universal parametrization assigns a parameter for which an i-th basic function has a maximum to the point P₁.

Next, at step 1002, two adjacent patch to be connected with Cⁿ⁻¹ among obtained patch.

At step 1003, from the selected two curved surfaces, control points are obtained and a control point of a large patch by blending superposed control points.

Then, at step 1004, B-spline curved surface patch is obtained by using the control points of the large patch.

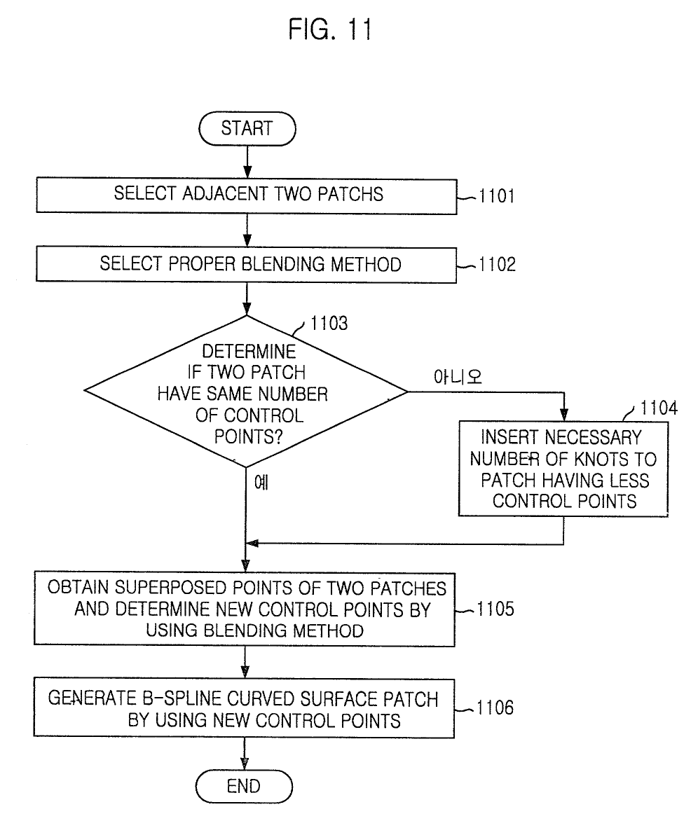

FIG. 11 is a flow chart for another embodiment of an algebraic blending method for accomplishing Cⁿ⁻¹ continuity at boundary of two B-spline curves/curved surfaces in accordance with the present invention, which shows the case that Knot insertion is required to have same number of control points, i.e., knots, in boundary direction connected in order that two B-spline curved surface patch are combined to a patch.

As shown in FIG. 11, at step 1101, adjacent two patch are selected. Then, at step 1102, the blending method is selected. For example, linear combination, i.e., αC₁+βD₁(α+β=1,α,β≧0), can be used.

Next, at step 1103, it is checked whether two patch have same number of control points.

At step 1105, if two patch have same number of the control points, superposed points of the two patch are obtained and new control points are obtained after combining corresponding control points by using the blending method. Then, at step 1106, the B-spline curved surface patch is generated by using the new control points.

At step 1104, if two patch does not have same number of the control points, knots are inserted to the patch having less control points. Then, the procedure proceeds to the step 1105 at which superposed points of the two patch are obtained and new control points are obtained after combining corresponding control points by using the blending method.

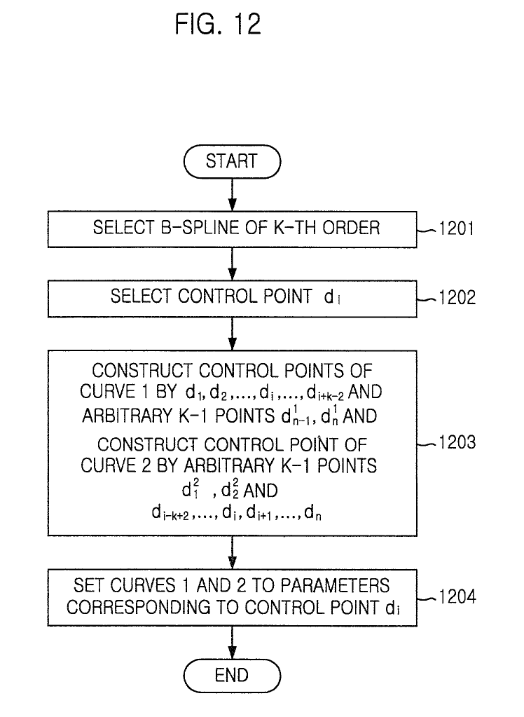

FIG. 12 shows a diagram for one embodiment of a method for separating a B-spline curve to two curves in accordance with the present invention.

Firstly, at step 1201, a B-spline of k-th order is selected and, at step 1202, a control point d₁ is selected, from which the selected B-spline curve is separated.

Then, at step 1203, assuming that the separated curves are curve 1 and 2, the control points of the curve 1 are constructed by d₁, d₂, . . . , d₁, d₁, . . . , dᵢ₊ₖ₋₂ and an arbitrary k−1 points d¹ₙ₋₁, d¹ₙ and the control point of the curve 2 are constructed by an arbitrary k−1 points d²₁, d₂² and dₗ₋ₖ₊₂, . . . , d₁, d₁₊₁, . . ., dₙ.

Next, at step 1204, the curve 1 and 2 are set to parameters corresponding to the control point d₁.

As described above, the method of the present invention is implemented by a program that stored at computer readable medium, e.g., CD-ROM, RAM, ROM, floppy disk, hard disk, optical magnetic disk and etc.

Also, as described above, the method of the present invention is applied to various computing apparatus processing to present naturally an image from a geometric modeling apparatus like CAD/CAM, a three dimension game apparatus and an animation apparatus.

As described above, the present invention can reduce the number of curves or curved surface patch of an original model by repeating merging two n-th curve/curved surface to a n-th curve/curved surface to have continuity at boundary of two B-spline curves/curved surfaces.

While the present invention has been shown and described with respect to the particular embodiments, it will be apparent to those skilled in the art that many changes and modifications may be made without departing from the spirit and scope of the invention as defined in the appended claims.

What is claimed is:

1. An algebraic blending method for accomplishing continuity at boundary of two B-spline curves or curved surfaces for use in a computing apparatus, the method comprising the steps of:
(a) obtaining a B-spline curved surface patch by using universal parametrization;
(b) selecting two adjacent patch to be connected with continuity among the patch obtained at the step (a);
(c) obtaining at least one control point of a large patch by obtaining control points of the selected two curved surfaces and blending superposed control points; and
(d) obtaining a B-spline curved surface patch by using the obtained control points of the large patch and replacing it with the two patch of the original model.

2. The method as recited in claim 1, wherein the continuity is Cⁿ⁻¹ continuity (maximum continuity that n-th B-spline curve or curved surface can have).

3. An algebraic blending method for accomplishing continuity at boundary of two B-spline curves or curved surfaces for use in a computing apparatus, the method comprising the steps of:
(a) selecting two adjacent patch and selecting a proper blending method;
(b) checking whether the selected two patch have same number of the control points;
(c) if the two patch have same number of the control points, obtaining superposed control points of the two patch, blending the corresponding control points by the selected blending method to a new control points, and generating a b-spline curved surface patch by using the new control points; and
(d) if the two patch does not have same number of the control points in direction of boundary, inserting Knots to the patch having less control points, obtaining control points superposed at the two patch of the step (c), blending the corresponding control points by the selected blending method, and proceeding to the step of obtaining the new control points.

4. The method as recited in claim 3, wherein the continuity is Cⁿ⁻¹ continuity (maximum continuity that n-th B-spline curve or curved surface can have).

5. A method for separating two B-spline curves to two curves for use in a computing apparatus, the method comprising the steps of:
(a) selecting the B-spline curve and separating the selected B-spline curve by selecting a control point d₁ at which the selected B-spline curve is separated;
(b) constructing control points of one curve of the separated curves by d₁, d₂, . . . , dₗ, . . . , dₗ₊ₖ₋₂ and arbitrary k−1 points dₙ₋₁¹, dₙ¹ and constructing control points of the other curve of the separated curves by arbitrary k−1 points d₁², d₂² and dᵢ₋ₖ₊₂, . . . , d₁, d₁₊₁, . . . , dₙ; and
(c) setting respectively the separated two curves to parameters corresponding to the control point d₁.

6. A computer readable medium for recording a program for implementing in a geometric modeling apparatus the functions of:
(a) obtaining a B-spline curved surface patch by using universal parameters;
(b) selecting two adjacent patch to be connected with continuity among the patch obtained by the function (a);
(c) obtaining at least one control point of a large patch by obtaining control points of the selected two curved surfaces and blending superposed control points; and
(d) obtaining a B-spline curved surface patch by using the obtained control points of the large patch and replacing it with the two patch of the original model.

7. A computer readable medium for recording a program for implementing in a geometric modeling apparatus the functions of:
(a) selecting two adjacent patch and selecting a proper blending method;
(b) checking whether the selected two patch have same number of the control points;
(c) if the two patch have same number of the control points, obtaining superposed control points of the two patch, blending the corresponding control points by the selected blending method to a new control points, and generating a b-spline curved surface patch by using the new control points; and
(d) if the two patch does not have same number of the control points in direction of boundary, inserting Knots to the patch having less control points, obtaining control points superposed at the two patch of the function (c), blending the corresponding control points by the selected blending method, and proceeding to the step of obtaining the new control points.

8. A computer readable medium for recording a program for implementing in a geometric modeling apparatus the functions of:
(a) selecting the B-spline curve and separating the selected B-spline curve by selecting a control point d₁ at which the selected B-spline curve is separated;
(b) constructing control points of one curve of the separated curves by d₁, d₂, . . . , d₁, . . . d₁₊ₖ₋₂ and arbitrary k−1 points dₙ₋₁¹, dₙ¹ and constructing control points of the other curve of the separated curves by arbitrary k−1 points d₁², d₂² and dᵢ₋ₖ₊₂, . . . , d₁, dᵢ₊₁, . . . , dₙ; and
(c) setting respectively the separated two curves to parameters corresponding to the control point dᵢ.
